(19) United States
(12) Patent Application Publication
(10) Pub. No.: US 2009/0193230 A1
(43) Pub. Date: Jul. 30, 2009

(54) COMPUTER SYSTEM INCLUDING A MAIN PROCESSOR AND A BOUND SECURITY COPROCESSOR

(76) Inventors: Ralf Findeisen, Dresden (DE); Geoffrey S. Strongin, Austin, TX (US); Andrew R. Rawson, Austin, TX (US); Garth D. Hillman, Lakeway, TX (US); Gary H. Simpson, Framingham, MA (US)

Correspondence Address: MEYERTONS, HOOD, KIVLIN, KOWERT & GOETZEL (AMD), P.O. BOX 398, AUSTIN, TX, 78767-0398, US

(21) Appl. No.: 12/022,446

(22) Filed: Jan. 30, 2008

(51) Int. Cl. G06F 15/80

(52) U.S. Cl. 712/34

(57) ABSTRACT

A computer system includes a main processor and a security control processor that is coupled to the main processor and configured to control and monitor an operational state of the main processor. To ensure the computer system may be trusted, the security control processor may be configured to hold the main processor in a slave mode during initialization of the security control processor such that the main processor is not operable to fetch and execute instructions from an instruction source external to the main processor, for example. In addition, the security control processor may be configured to initialize the operational state of the main processor to a predetermined state by transferring to the main processor via a control interface one or more instructions and to cause the main processor to execute the one or more instructions while the main processor is held in the slave mode.

### BACKGROUND OF THE INVENTION

1. Field of the Invention

This invention relates to computer system security and, more particularly, to computers systems employing a secure platform.

2. Description of the Related Art

Many conventional computer systems and the software executing on them are vulnerable to attack from both software and hardware mechanisms. Depending on the assets that need to be protected, system designers tasked with building secure systems may be faced with a variety of problems associated with keeping parts of the system software trustworthy. System software, which may include, for example, the operating system, application software, and basic input output system (BIOS), may be compromised in many ways. The Operating System software may be attacked by viruses and other malware. External storage such as flash, read only memory (ROM) or hard drives may be independently manipulated. Systems that work with digital rights management (DRM) may be compromised by a user trying to violate a license. The list goes on.

Since system software may be vulnerable on any given conventional computer system, it has become harder for providers and users of such services as online banking, online securities trading, multimedia content providers, and the like from running software applications in a secure environment.

### SUMMARY

Various embodiments of a computer system and method are disclosed. In one embodiment, the computer system includes a main processor and a security control processor that is coupled to the main processor and configured to control and monitor an operational state of the main processor. To ensure the computer system may be trusted, the security control processor may be configured to hold the main processor in a slave mode during initialization of the security control processor such that the main processor is not operable to fetch and execute instructions from an instruction source external to the main processor, for example. In addition, the security control processor may be configured to initialize the operational state of the main processor to a predetermined state by transferring to the main processor via a control interface one or more instructions and to cause the main processor to execute the one or more instructions while the main processor is held in the slave mode.

Further, to help ensure the system has not been hijacked by, for example, replacing the security control processor with a different processor, the security control processor and the main processor may be bound together using a binding operation. In one particular implementation, prior to the security control processor releasing the main processor to operate in the normal operational mode, the security control processor is configured to initiate a binding verification operation, during which the main processor and the security control processor validate each other. In response to a successful binding verification operation the main processor is configured to operate in the normal operational mode.

### BRIEF DESCRIPTION OF THE DRAWINGS

FIG. 1 is a block diagram of one embodiment of a computer system employing a security control processor.

FIG. 2 is a flow diagram describing the operation of an embodiment of a computer system employing a security control processor.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

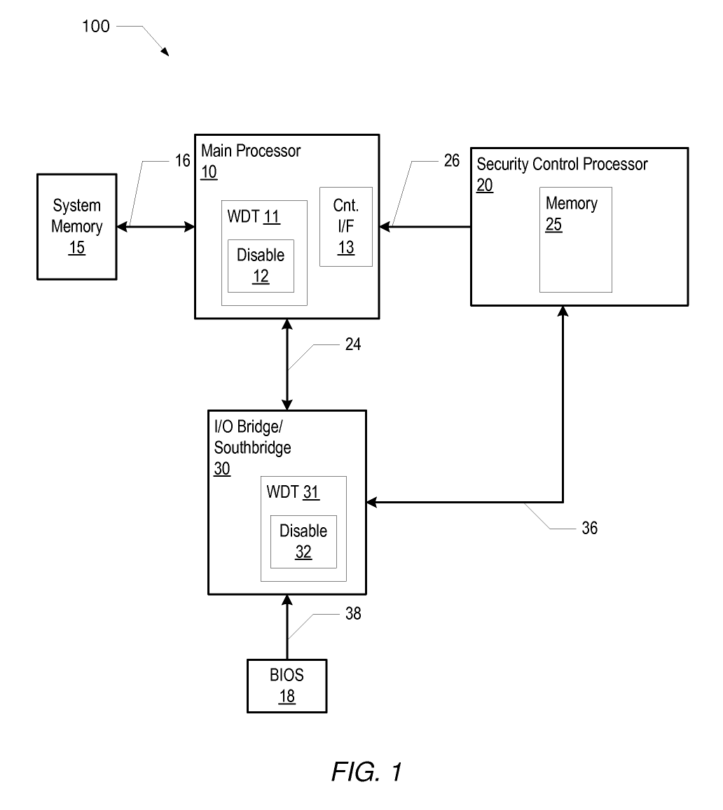

Turning now to FIG. 1, a block diagram of one embodiment of a computer system is shown. The computer system 100 includes a main processor 10 coupled to a system memory 15 via a memory link 16. The main processor 10 is also coupled to an input/output (I/O) bridge 30 via an I/O link 24. In addition, the main processor is coupled to a security control processor 20 via a control interface 26. The I/O bridge 24 is coupled to the security control processor 20 via a peripheral bus 36. The I/O bridge 24 is also coupled to a basic input output (BIOS) storage 18 via a peripheral bus 38. It is noted that although the BIOS is coupled to the I/O bridge 24 as shown, it is contemplated that in other embodiments, the BIOS 18 may be coupled to the system in other ways. It is also noted that for simplicity, a number of other computer system components have been omitted. For example, computer system 100 may include I/O devices such as a keyboard, mouse, display, and peripheral devices such as graphics adapters, as well as additional processors, coprocessors, and the like.

In one embodiment, the processor 10 may be representative of any of a variety of processors that implement the x86 architecture. However, it is noted that in other embodiments, main processor 10 may implement any type of architecture. In addition, since main processor 10 may be any type of exemplary microprocessor, main processor 10 may include many other components and functional blocks such as instruction and data caches, load and store units, fetch and decode logic, and one or more execution units that have been omitted for simplicity.

As shown, main processor 10 is coupled to the security control processor 20 via a control interface 26. As such, main processor 10 includes control interface logic 13. As will be described in greater detail below the control interface logic 13 may include functionality that enables security control processor 20 to control and monitor the operational state of the main processor 10 at all times. The operational state of the main processor may be described by the data memory image, register settings, instructions to be executed (can be another memory image), its caches and other internal processor state. For example, the control interface logic 13 may include test access port (TAP) controller registers that may allow security control processor 20 to have direct access to the processor instruction cache I-Cache (not shown), among other hardware functions of the main processor 10. In one embodiment, control interface 26 and control interface logic 13 may be implemented as an advanced debug port, which may include functionality that is compliant with the well-known IEEE 1149.1 Boundary Scan Standard, which is also sometimes referred to as the joint test action group (JTAG) standard. The boundary scan standard includes a serial test interface having a plurality of externally accessible pins including TDI, TDO, TMS, TCK and TRST. However, the control interface 26 and control interface logic 13 may include additional signals and features making it a superset of the IEEE 1149.1 Boundary Scan Standard. For example, in one embodiment, the debug port may be implemented as a proprietary hardware debug tool (HDT) port by Advanced Micro Devices, Inc. As such the port may include such pins as a debug request pin (DBREQ_L) and a debug ready pin (DB_RDY), for example. In such an embodiment, the DBREQ_L may be assigned externally and the debug HW may answer by asserting the DB_RDY signal when complete.

In addition, as shown in the illustrated embodiment, main processor 10 includes a watchdog timer (WDT) circuit 11 that may be implemented in hardware. The WDT circuit 11 also includes a disable mechanism 12. It is noted that in other embodiments, there may be no WDT circuit 11, and the disable mechanism 12 may have stand-alone functionality (i.e., may be used without WDT circuit 11). As will be described in greater detail below, the disable mechanism 13 may be part of a distributed watchdog function in which all or some of the system components may participate. In one embodiment, the disable mechanism 12 may respond to a signal from any WDT circuit such as WDT circuit 11, for example, by disabling main processor 10, either permanently or temporarily, and either completely or partially, dependent upon the specific implementation.

The I/O bridge 30 may be implemented as an I/O hub or southbridge depending on the specific implementation. In one embodiment, I/O link 24 may be implemented as a HyperTransport™ (HT) link, in which a pair unidirectional links may convey packets between main processor 10 and I/O bridge 30. As such, I/O bridge 30 may include support logic such as input and output buffers, and flow control logic to control the HT link. In addition, I/O bridge 30 may include bridge logic to support communication to peripheral buses such as peripheral bus 36. For example, in one embodiment, peripheral bus 36 and bus 38 may be representative of low pin count (LPC) buses, or a peripheral component interconnect (PCI) bus, or the like. Accordingly, I/O bridge 30 may include bridge logic (not shown) to bridge communications between and HT protocol and an LPC or PCI protocol. It is noted that in other embodiments, I/O link 24 may be implemented using any type of communication or bus protocol, as desired.

The security control processor 20 may communicate to the main processor 10 via the control interface 26 and through the LPC bus 36 via the I/O bridge 30. In one embodiment, the control interface 26 is a one-way interface since the main processor 10 may not initiate communications to the security control processor 20 via the control interface 26. As described above, the security control processor 20 may monitor and control the state of main processor 10 via the control interface 26. More particularly, using special control interface instructions, security control processor 20 may read and write to all components that make up the CPU state of main processor 10. For example, security control processor 20 may upload instructions, and read and write system registers from the main processor 10 through the control interface 26.

As illustrated, I/O bridge 30 also includes a WDT circuit 31 that may be implemented in hardware. Similar to the WDT 11 of the main processor 10, the WDT circuit 31 also includes a disable mechanism 32. However, as described above, in other embodiments, there may be no WDT circuit 31, and the disable mechanism 32 may have stand-alone functionality, and may be used without WDT circuit 31. As will be described in greater detail below, the disable mechanism 32 may be part of a distributed watchdog function in which all or some of the system components (e.g., main processor 10, security control processor 20, etc) may include WDT circuit hardware and may participate WDT events. In one embodiment, the disable mechanism 33 may respond to a signal from any WDT circuit such as WDT circuit 11 or WDT circuit 31, for example, by disabling I/O bridge 30, either permanently or temporarily dependent upon the specific implementation.

In the illustrated embodiment, the security control processor 20 is coupled o the main processor 10 via the control interface 26 and to the I/O bridge 30 via a peripheral bus 36 (e.g., LPC). In one embodiment, the security control processor 20 may be implemented as a special purpose processor. As such, the security control processor 20 may include various special security features such as an internal memory 25 that is inaccessible from outside the security control processor 20 once it has been programmed. In addition, in one embodiment, the security control processor 20 may be implemented such that it is protected from tampering and reverse engineering. The security control processor 20 may also include the ability to perform cryptographic functions.

In one embodiment, the security control processor 20 may be configured to execute program instructions stored within the internal memory 25. The program instructions, once executed may cause the security control processor 20 to control the boot-up sequence of the main processor 10 and computer system 100, and to control and monitor the operation of the main processor 10 at all times. For example, to ensure the security of the system, the security control processor 20 may be configured to validate the BIOS code within BIOS storage 18, prior to allowing the man processor 10 to load and execute the BIOS code.

In addition, the security control processor 20 may be configured to manipulate the operational state of the main processor 10 and to upload instructions into the instruction cache of the main processor 10 prior to allowing the main processor 10 to be released from a slave mode. For example, in one embodiment, the security control processor 20 may hold the main processor in a slave mode. As used herein, the slave mode is a mode during which, the main processor may execute instructions in a debug or lock step fashion from its internal instruction cache when under control of the debug port, for example. In addition, when in the slave mode, some circuits within the main processor 10 may, in fact, be held in a traditional reset. However, other circuits, such as some clock circuits and some debug circuits may be operational. In addition, when in the slave mode, the main processor 10 may not autonomously fetch instructions from system memory 15 and execute those instructions. It is noted that during runtime, when data items are not necessarily secret, for example, memory other than the internal instruction cache may be used.

The watchdog functionality, and in particular the WDT circuits 11 and 31 may be configured to monitor the presence and correct operation of the security control processor 20. For example, the security control processor 20 may be configured to send a message such as a stay alive or heartbeat message to each system component at predetermined intervals. In one embodiment, the security control processor 20 may be configured to send the message at periodic intervals or at some randomized (e.g., unpredictable, pseudorandom, true random, etc.) intervals within some predetermined maximum interval. Upon receipt of the stay alive message, the main processor 10 and the I/O bridge 30 may be configured to reset the disable mechanism (e.g., 13, 23). However, in the absence of the stay alive message, the disable mechanism(s) may be configured to disable or partially disable the hardware and/or functionality of the respective component within which they are implemented. It is noted that in one embodiment, partially disabling the main processor 10 may include causing the main processor 10 and thus, system 100 to operate in a limited functionality mode.

In one embodiment, the disable mechanism may be configured to simply pull the system reset, thereby resetting each of the main processor 10, the security control processor 20, and the I/O bridge 30. In another embodiment, the disable mechanism may be configured to individually reset one of the main processor 10, or the I/O bridge 30, or security control processor 20. However in other embodiments, to prevent the system from being used in any way other than its intended purpose, it is conceivable that disable mechanism(s) may be configured to more permanently disable hardware by, for example, blowing fuses or permanently damaging other internal hardware.

Alternatively, the disable mechanism may be configured to cause the main processor 10 to begin executing code that was previously stored within memory 25 or another memory that was under the control of security control processor 20 and transferred to main processor 10. This code may program main processor 10 and any other computer system component causing the system to enter the limited functionality mode. In the limited functionality mode, the main processor 10 and one or more components of the computer system 100 may be programmed to operate at a reduced level of functionality, as compared to the functionality in normal operational mode. Thus, the overall functionality of the computer system is reduced, and a user may find the computer to be less useful (or the user may even find the computer system not useful at all).

For example, there are many variations of programming the one or more components to enter the limited functionality mode. A non-exhaustive list of possibilities, one or more of which may be used in any combination, includes: programming the memory controller of the main processor 10 to limit the size of the memory to a minimal amount (e.g. sufficient storage for LFM code use, but not more); programming components to force the most significant address bits to zero, limiting the addressable memory space; disabling processors if more than one processor is included; disabling coprocessors, hardware accelerators, graphics processors, network offload engines, and other performance-enhancing assist circuits; disabling external interrupts and debug functionality; disabling processor and system caches; reducing the processor's operating frequency; reducing other operating frequencies (e.g. memory, peripheral interfaces, internal interfaces); reducing a size of the internal interfaces that have configurable widths (e.g. HyperTransport™ links); reducing the video display mode to a lowest possible resolution, or text only; programming the NIC(s) 24 to limit network connectivity to only sites that are authorized by the owner of the computer system; and disabling one or more peripheral devices (e.g. all devices except video, keyboard, and mouse); and the like.

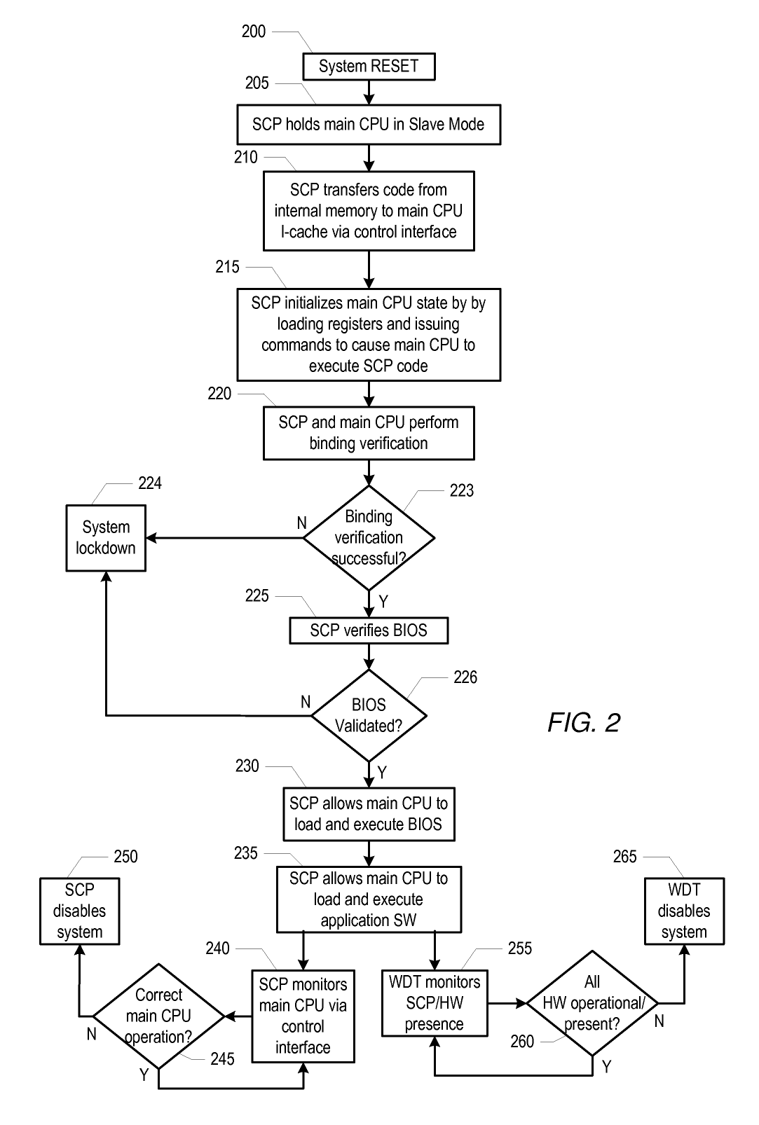

Referring to FIG. 2, a flow diagram describing the operation of an embodiment of a computer system such as computer system 100 is shown. Beginning in block 200, a system reset is initiated such as during a power on reset, for example. In response, the security control processor 20 begins to initialize. As part of the security control processor 20 initialization, it holds the main processor 10 in a slave mode (block 205). The security control processor 20 accesses an internal memory 25 that is inaccessible (via software or hardware) from outside the integrated circuit package of the security control processor 20. In one embodiment, the internal memory 25 may be programmed during manufacturing. However, after manufacturing programming, the internal memory 25 may not be programmed again, and the internal memory 25 becomes inaccessible to any other outside devices. Thus, in one embodiment the security control processor 20 runs on signed, fixed software that is proved by the manufacturer. This software checks the authenticity and integrity of all software before running it. In addition, in other embodiments, the security control processor 20 may use code stored in an external memory (e.g., ROM) when the security control processor 20 is able to check the authenticity and integrity of the code using, for example, internal code (e.g. SHA1, and RSA) and storage (e.g., a public key in ROM) to do the check.

The security control processor 20 transfers program instructions from the internal memory 25 to the main processor 10 via the control interface 26. In one embodiment, the security control processor 20 uses the control interface 26 to load the instructions into the instruction cache of the main processor 10 (block 210). In addition, the security control processor 20 may initialize various system registers within the main processor 10 by issuing commands and accessing system registers via the control interface 26. In addition, the security control processor 20 may cause the main processor 10 to execute the code stored in the instruction cache (block 215).

In one embodiment, the instructions when executed may initialize the main processor 10 to a known state and initiate a binding verification operation (block 220). More particularly, during manufacturing of the computer system, the security control processor 20 and the main processor 10 may be bound together such that only the bound devices are able to communicate with each other. More particularly, if the bound devices communicate using AES encryption, for example, only devices in possession of the key may participate. Accordingly, the binding process includes ensuring the bond devices have the same key. By binding the security control processor 20 and the main processor 10, neither component may be removed and replaced by a different component at a later time.

In one embodiment, the binding verification operation may include the main processor 10 performing cryptographic functions and/or randomized operations that may include generating a secret or key inside the main processor 10. Once the key is generated, the main processor 10 may validate the generated key with a key that was included with the program instructions sent from the security control processor 20. Similarly, the security control processor 20 may read a key value from a predetermined register within the main processor 10. The security control processor 20 may validate the key value. Thus, the binding verification operation may validate to the security control processor 20 that the main processor 10 is the one and only correct processor to which it is coupled. Likewise, the main processor 10 may validate the security control processor 20 as the one and only correct security processor to which it is coupled. It is contemplated that a number of different mechanisms exist to bind the two processors. For example, an asymmetric cryptographic solution in which public/private keys may be implemented, or any other mechanism in which the keys are exchanged in a secure way such that the security control processor 20 and the main processor 10 can verify the binding. If the binding verification operation fails (block 223), either or both the security control processor 20 or the main processor 10 may retry the operation. And if the binding verification operation fails again, the system may go into a lock down mode, in which the main processor 10 becomes inoperable (block 224).

If the binding verification process is successful (block 223), the security control processor 20 validates the BIOS program instructions (block 225). If the BIOS is not validated (block 226), the security control processor 20 may cause the system to go into a lock down mode, in which the main processor 10 becomes inoperable (block 224). However, if the BIOS is validated (block 226), the security control processor 20 releases the main processor 10 and allows the main processor 10 to begin initialization and to load and execute the BIOS code (block 230) and to begin loading and executing the operating system code and application software and to enter into a normal operational mode (block 235).

During operation, the security control processor 20 continually monitors and controls the operational state of the main processor 10 via the control interface 26 (block 240), while the WDT circuits described above may monitor the presence of the security control processor 20 using the stay alive signal (block 255).

If the operation of the main processor 10 is deemed to be correct by the security control processor 20 (block 245), the security control processor 20 continues monitoring the operation (block 240). However, if the operation of the main processor 10 is deemed not to be correct by the security control processor 20 (block 245), the security control processor 20 may disable the system, or cause the main processor 10 to be inoperable (block 250), or to operate in a reduced capacity. For example, in one embodiment when certain application software executes, it may include a signature value that is stored in a particular memory location or register. In one embodiment the signature value represents the encrypted result of a one-way function, mapping the whole binary code of the software into a certain number space (e.g., 160-bit numbers). In other words, the resulting number represents the code. There must be no way for controlled generation of a certain number and there must be no way back. The security control processor 20 may load and verify that signature. If the key matches, then the main processor 10 is allowed to continue. If it doesn't match, the security control processor 20 may halt operation of the main processor 10. In one embodiment, all software that executes on main processor 10 must be validated to prevent unauthorized software and malware from running. Thus, security control processor 20 may prevent the computer system 100 from being hijacked or repurposed.

The WDT circuits described above may monitor the presence of the security control processor 20 using the stay alive signal (block 255). If the WDT circuit(s) continue to detect the stay alive signal signifying the security control processor 20 is present and operating (block 260), the WDT circuit(s) continue to monitor the presence of the security control processor 20 using the stay alive signal (block 255). However, if WDT circuit(s) fail to detect the stay alive signal within the maximum allowable timeout period, the disable mechanism(s) may disable or partially disable the computer system in a variety of ways, as discussed above (block 265). Thus, the WDT circuit(s) may prevent an attack that attempts to replace the original security control processor 20 from being removed and tampered with, or replaced with a different processor after the system has initialized into normal operation.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A computer system comprising:
a main processor;
a security control processor coupled to the main processor and configured to control and monitor an operational state of the main processor;
wherein the security control processor is configured to hold the main processor in a slave mode during initialization of the security control processor such that the main processor is not operable to fetch and execute instructions from an instruction source external to the main processor;
wherein the security control processor is further configured to initialize the operational state of the main processor to a predetermined state by transferring to the main processor via a control interface one or more instructions and to cause the main processor to execute the one or more instructions while the main processor is held in the slave mode.

2. The system as recited in claim 1, wherein the security control processor is configured to control and monitor the operational state of the main processor state at all times.

3. The system as recited in claim 1, wherein the one or more instructions are transferred from a memory storage controlled and verified by the security control processor to an instruction cache within the main processor.

4. The system as recited in claim 1, wherein the control interface comprises a debug port including a port controller, one or more data signals and a control signal.

5. The system as recited in claim 1, wherein the control interface provides communication between the security control processor and the main processor that is initiated only by the security control processor.

6. The system as recited in claim 1, wherein prior to the security control processor releasing the main processor to operate in the normal operational mode, the security control processor is configured to validate basic input output system (BIOS) instructions stored within a memory storage device.

7. The system as recited in claim 6, wherein in response to the security control processor releasing the main processor to operate in the normal operational mode, the main processor is configured to load the BIOS instructions from the memory storage device.

8. The system as recited in claim 1, wherein prior to the security control processor releasing the main processor to operate in the normal operational mode, the security control processor is configured to initiate a binding verification operation, during which the main processor and the security control processor validate each other, wherein in response to a successful binding verification operation the main processor is configured to operate in the normal operational mode.

9. The system as recited in claim 1, wherein the main processor includes a watchdog timer circuit configured to, during operation in the normal operational state, monitor a signal that indicates the security control processor is present and operational.

10. The system as recited in claim 9, wherein the watchdog timer circuit is configured to provide a watchdog timeout notification to the main processor in response to determining the present signal is indicating the security control processor is either not present or not operating correctly.

11. The system as recited in claim 10, wherein the main processor includes a disable circuit configured to at least partially disable the main processor in response to receiving the watchdog timeout notification.

12. The system as recited in claim 1, further comprising an input output (I/O) bridge coupled to the main processor via a first communication link and to the security control processor via a second communication link, wherein the I/O bridge comprises a watchdog timer circuit configured to monitor a present signal that indicates the security control processor is present and operating normally, and to provide a watchdog timeout notification to the main processor in response to determining the present signal is indicating the security control processor is either not present or not operating correctly.

13. The system as recited in claim 12, wherein the main processor includes a disable circuit configured to disable the main processor in response to receiving the watchdog timeout notification.

14. A method of securing a computer system, the method comprising:
providing a main processor;
coupling a security control processor to the main processor via a control interface;
the security control processor controlling and monitoring an operational state of the main processor;
the security control processor holding the main processor in a slave mode during initialization of the security control processor, wherein during the slave mode, the main processor is not operable to fetch and execute instructions from an instruction source external to the main processor;
the security control processor initializing the operational state of the main processor to a predetermined state by transferring to the main processor via the control interface one or more instructions;
the security control processor causing the main processor to execute the one or more instructions while the main processor is held in the slave mode.

15. The method as recited in claim 14, further comprising the security control processor controlling and monitoring the operational state of the main processor at all times.

16. The method as recited in claim 14, further comprising transferring the one or more instructions from a memory storage controlled and verified by the security control processor to an instruction cache within the main processor.

17. The method as recited in claim 14, wherein the control interface comprises a debug port including a port controller, one or more data signals and a control signal.

18. The method as recited in claim 14, further comprising the control interface providing communication between the security control processor and the main processor that is initiated only by the security control processor.

19. The method as recited in claim 14, further comprising the security control processor validating basic input output system (BIOS) instructions stored within a memory storage device prior to the security control processor releasing the main processor to operate in the normal operational mode.

20. The method as recited in claim 14, further comprising the security control processor initiating a binding verification operation, during which the main processor and the security control processor validate each other prior to the security control processor releasing the main processor to operate in the normal operational mode, wherein in response to a successful binding verification operation the main processor operating in the normal operational mode.

21. The method as recited in claim 14, further comprising, during operation in the normal operational state, a watchdog timer circuit within the main processor monitoring a present signal that indicates the security control processor is present and operational.

22. The method as recited in claim 21, further comprising the watchdog timer circuit providing a watchdog timeout notification to the main processor in response to determining the present signal indicating the security control processor is either not present or not operating correctly.

23. The method as recited in claim 22, further comprising a disable circuit within the main processor at least partially disabling the main processor in response to receiving the watchdog timeout notification.

24. The method as recited in claim 14, further comprising a watchdog timer circuit within an input output (I/O) bridge coupled between the main processor and the security control processor monitoring a present signal that indicates the security control processor is present and operating normally, and providing a watchdog timeout notification to the main processor in response to determining the present signal indicating the security control processor is either not present or not operating correctly.

25. The method as recited in claim 24, further comprising a disable circuit within the main processor disabling the main processor in response to receiving the watchdog timeout notification.
